(19) United States
(12) Patent Application Publication
(10) Pub. No.: US 2008/0187710 A1
(43) Pub. Date: Aug. 7, 2008

(54) PROTECTIVE CHAIR MAT WITH OR WITHOUT REVERSIBLE SURFACE DECOR

(75) Inventors: Oliver O. Stanchfield, Garner, NC (US); Sven Kornfalt, Malmo (SE); Patrick George Smith, Raleigh, NC (US); Ane Elholm, Cary, NC (US)

Correspondence Address: NOVAK, DRUCE + QUIGG L.L.P., 1300 Eye Street, N.W., 1000 West Tower, Washington, DC, 20005, US

(73) Assignee: PERGO (EUROPE) AB, Trelleborg (SE)

(21) Appl. No.: 12/022,839

(22) Filed: Jan. 30, 2008

Related U.S. Application Data
(60) Provisional application No. 60/899,374, filed on Feb. 5, 2007.

(51) Int. Cl. B32B 3/06

(52) U.S. Cl. 428/99; 428/542.2

(57) ABSTRACT

A protective mat, coaster or cutting board are embodiments of some products that can be obtained from the present invention. In one such embodiment, a floor mat having two major surfaces, i.e., an upper and lower surface, each of which can optionally be formed of a laminate, preferably, but not necessarily, having different decors, is provided. The floor mat can be made in one piece, but preferably, is assembled from several pieces, optionally packaged as a kit, in combination with joining elements and optionally an edge border, or glue, and/or gripping pad or pads.

This application claims priority from U.S. Provisional Application No. 60/899,374, filed Feb. 5, 2007, herein incorporated by reference in its entirety.

### FIELD OF THE INVENTION

The invention is a one-piece or multi-piece laminate structure which can be used to provide protection for surfaces, such as furniture, countertops, carpet or other floor structures from wear (such as scratching and abrasion), while simultaneously providing a decorative décor to the structure. The structures can be in the form of chair mats, coasters, cutting boards and other forms of protective laminates.

### DESCRIPTION OF RELATED ART

Office chairs are often provided with casters to allow the user to roll the chair while seated. To lower rolling resistance and to protect the floor from wear, it is common to use a chair mat. A conventional chair mat is typically constructed of a clear or translucent sheet vinyl material (pliable or rigid) having a relatively smooth upper surface and a bottom surface optionally provided with a plurality of integrally molded spikes for engaging a carpeted floor. One of the drawbacks of such conventional vinyl chair mats is that the vinyl tends to crack over time, losing its integrity. Besides being aesthetically unpleasing, conventional chair mats commonly become fragmented along the cracks so that pieces of the mat can become detached, exposing the flooring below. Chair mats comprising a carpet layer on the appearance side are also known. Such carpeted chair mats, however, do not allow the casters to roll as easily as on a smooth, hard surface.

Additionally, due to the presence of such integrally molded spikes, conventional vinyl chair mats are designed to be used only with carpeted surfaces. Therefore, protection for vinyl, hardwood or laminate floors cannot be provided by the conventional chair mats.

U.S. Pat. No. 6,103,333 (herein incorporated by reference) is an attempt to cure many of these deficiencies, but utilizes a unique combination of a plastic vinyl layer sandwiched between a wood veneer layer and an impregnated backing sheet. This structure, while a significant improvement over known chair mat systems, requires the plastic core to flex or bend. This flexure and/or bending can cause undesired wear and damage to the chair mat during use. Other chair pads or mats can be found in U.S. Patent Publication No. 2006/020181A1 and U.S. Pat. No. 6,588,167, both incorporated herein by reference.

### SUMMARY OF THE INVENTION

A prior attempt to improve upon the known chair mat systems is disclosed by U.S. Pat. No. 6,103,333. This disclosure states that the only way to prevent warping was to provide a wood veneer over a PVC core, over an impregnated backing sheet. However, such an approach severely limits the overall appearance, function and desirability of this prior art attempt.

In contrast, the present invention, in one embodiment, has a bonded element including a core material, which is formed from cellulosic, natural, synthetic, or polymeric materials. A first décor is then applied to the core material. Preferably, a second décor is provided on the opposite side of the core material. Surprisingly, despite not utilizing the unique combination described by U.S. Pat. No. 6,103,333, no warping was observed.

### BRIEF DESCRIPTION OF THE DRAWINGS

FIG. 1 shows the sandwich structure of the invention.

FIG. 2 shows a top view of the structure of the invention.

FIG. 3 shows a view of a typical joint used in accordance with the invention.

FIG. 4 shows an alternative type of joint used in accordance with the invention.

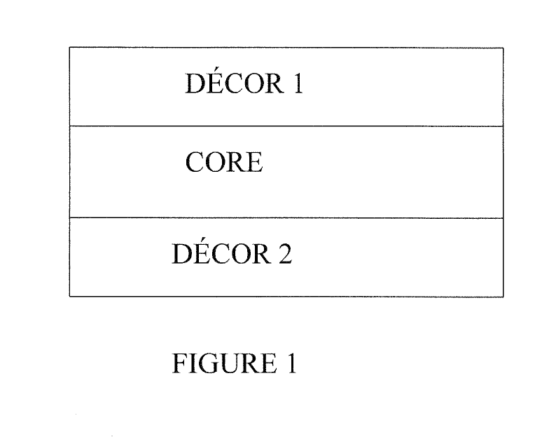

### DETAILED DESCRIPTION OF THE INVENTION

Suitable core materials may include one or more of wood, particleboard, fiberboard, such as high density fiberboard (HDF) or medium density fiberboard (MDF); polymer (thermosetting and thermoplastic, and in a solid, sheet or corrugated form) and especially phenolic laminate; flaxboard, stone (e.g., ceramic, marble, slate), cardboard, concrete, gypsum, high density fiber reinforced plaster, plywood, oriented strand board, cores made from cellulosic particles (including discrete pieces of wood, which can be veneers, chips, curls, flakes, sawdust, shavings, slivers, stands, wafers, wood flour, wood wool and/or wood fibers) bonded together by an organic or inorganic binder; and other structural materials, such as metals (e.g., brass, aluminum, steel, copper, composites, composites or alloys). In some embodiments, the core material can be foamed (either open cell or closed cell), such as polyurethane. In still further embodiments, the core is made from multiple materials (such as those listed above), either as a heterogeneous mass, multiple layers or defined sections. In some embodiments, it is desirable, e.g., for acoustic, footfall impact or other reasons to include a damping foil of an elastomer arranged between the core and the upper and/or lower decorative surface. Suitable elastomer materials are described in U.S. Pat. No. 6,893,713, the entire disclosure of which is herein conventional by reference. A particularly preferred laminate is made from a core of phenolic resin impregnated papers, otherwise known as compact laminate, onto which each of the upper and lower decorative surfaces is also laminated. A dampening foil or foils may also be included in such an embodiment. The entire compact laminate, including the decorative laminate, and any dampening foils can be made in one step in a EL press. Any of the above materials, such as the core and decorative layers, may also be provided with antistatic or antibacterial properties, e.g., by the inclusion of silver flakes, powders or particles, organic antibacterial compounds, carbon black, ceramics, or other metals or alloys. Preferred plastics include extrudable and/or moldable thermosetting and thermoplastic resins, the latter including high density olefins and polyvinylchloride, and the former including phenolics, such as phenol-formaldehyde and UV or radiation curable resins, such as melamine based resins, e.g., melamine formaldehyde.

The first décor typically includes laminate which can be formed as a single, unitary, monolithic surface. This first décor may be decorated, for example, with a laminate or a paper, such as a monochromatic or patterned décor, optionally impregnated with a resin, in order to increase its aesthetic value, or blend, to match or contrast with the floor panels or any other décor in the desired vicinity of use for the panels. Preferably, the first décor has incorporated therein at least one material to increase its abrasion resistance, such as hard particles of silica, alumina, diamond, silicon nitride, aluminum oxide, silicon carbide or mixtures thereof and similar hard particles, preferably particles having a Moh's hardness of at least approximately 6. This first laminate may also be covered with other types of coverings, such as foils (such as metal, paper or thermoplastic foils), paints or a variety of other decorative elements, including, but not limited to wood veneer, ceramic, metal, vinyl or other decorative materials.

The first décor may also be formed directly on the core (or a primer layer on the core), as described by, e.g., U.S. Pat. No. 6,465,046 (herein incorporated by reference in its entirety), for example by printing on the core. Such a printed décor may be printed directly on the core material by a digital process, such as by a conventional inkjet or laser-type printer. In one embodiment, the core is optionally provided with a solid primer and/or a base color, on which the decorative pattern or display is printed or otherwise generated. While the term “pattern” is used herein, it is to be understood that “pattern” need not be or include any repeating units, thus “pattern” is simply a visual or textual display. Once the décor is complete, the digitally printed décor can be covered with a wear layer, thereby giving the décor abrasion and/or scratch resistance. The wear layer can be provided in the form of a sheet of alpha-cellulose which is bonded to the core, or it can be applied in a liquid form optionally containing individual cellulosic fibers.

Often, the décor is provided with a patterned paper sheet therein, wherein the pattern resembles a natural or synthetic object, such as wood, ceramic, stone (including marble and granite), animation characters or features or fantasy patterns (i.e., those not found in nature), including a monochromatic or random field.

The second décor, i.e., on the opposite side of the décor from the first décor is usually (but need not be) different than the first décor, and can be made from any of the materials and/or patterns (visual and/or textual) as described herein.

The resulting products typically have durability rating. As defined by the European Producers of Laminate Flooring, such products can have an abrasion resistance rating of anywhere from AC1 to AC5. Typical abrasion resistances are >300 cycles, >400 cycles, >500 cycles, at least 900 cycles (AC1), at least 1800 cycles (AC2), at least 2500 cycles (AC3), at least 4000 cycles (AC4) and at least 6500 cycles (AC5), as measured by European Standard EN 13329 (Annex E). Typical products according to the invention can also have impact resistance ratings of IC1, IC2 or IC3, as measured by European Standard EN 13329.

Moreover, it is possible to provide the decor with a texture which enhances the pattern of the underlying paper sheet. Such texturing can be created to be “in register” with, offset from, or to contrast with the image of the paper sheet. Such texturing may be created by physical pressing, e.g., embossing (as taught by U.S. application Ser. No. 10/440,317 (filed May 19, 2003), U.S. Pat. No. 7,003,364, and WO9731775 and WO9731776) or chemically created (as taught by U.S. Pat. No. 6,991,830), the entire disclosures of which are herein incorporated by reference. The texture can be selected by the installer to enhance (e.g., match or contrast with) any texture of adjacent or included surfaces. The texture may also be provided on the decor such that features of the texture extend from a flooring element onto and possible completely across the adjacent flooring elements, which texture may, or may not coincide with the underlying décor. Features of the pattern based on stone or wood may include grains, veins, cracks and/or knots, and those of animation and/or fantasy may include details of the faces, such as wrinkled skin, frown marks, details of the eyes, ears, mouth, teeth, hands, fingers, etc. of the animation and/or fantasy patterns.

Although a roller or press plate are commonly used to provide the décor with a texture, a laser is also possible, as lasers or other etching techniques will produce textures having significantly greater specificity, than those made with rollers or press plates. Laser and etching techniques additionally provide increased detail, allowing for finer depressions, cuts, grooves, etc, as well as undercuts in the depression and grooves not otherwise possible with more traditional methods as such a roller or press plate.

The laser can be used to etch or cut directly into the core material before any layer is applied thereto, or in the case of providing a visual pattern directly on the core, before the ink or other pigment is applied. In an alternative, the laser can be used to cut or etch the surface after the visual pattern (e.g., resin-impregnated paper layer, with or without a wear layer thereon or directly printed pattern) has been applied. For example, it is within the scope of the invention to provide the core with the visual décor (e.g., resin-impregnated paper layer or printed pattern), and then etch the texture into the core, before applying any abrasion resistant layer, or provide the abrasion resistant layer before etching or cutting the core. Although less preferred, the texture can be provided by a procedure, e.g., including a mask, whereby an etching material is laid down in a particular pattern and exposure to, e.g., UV-light, IR-light, or radiation or other mechanical, thermal, optical, or chemical stimulus causes the etching material to form the texture in the wear layer, visual pattern layer and/or core. Either one or both sides of the core can be provided with a texture by this method.

By providing the texture by an etching or laser process, the previous scratching of press plates or rolls by the hard particles can be avoided.

The mat may be used over the above flooring surfaces and beneath office or other chairs for the purpose of protecting the finished flooring surfaces beneath the mat and to ease the movement of the chair, such as, rolling or pushing.

Best Mode for the Construction of a Chair Mat:

A chair mat 10 may be constructed of a variety of materials and material thickness. This material can be shaped in a variety of formats to accommodate the user's preference.

The material can be, but is not limited to, vinyl, wood, plastic, metal and composites.

The preferred example can be made of HDF or MDF materials and covered with a DL (direct laminate) or an HPL (high pressure laminate) on one or both sides of the mat, which are typically different, but may be the same. The surface or surfaces are not limited to just laminate covering. Other coverings could be direct printed onto the core or printed onto a primer placed on the core or printed onto a paper placed on the core. Such printing may be digital, direct transfer, or other printing form.

The surface or surfaces may have a multitude of decors, fantasy designs, natural designs, pictorial, as examples of decors. Alternatively one or both of the surface or surfaces may be covered with foil, wood veneer, metal, plastic, vinyl or digitally printed, laser-electrographic, laser etched, direct or ink jet applications with UV cured inks or other forms of printing inks. However, preferably, at least one of the surfaces is a laminate, and the other is selected from the preceding examples.

The surface or surfaces may be textured in a variety of forms, such as to resemble natural wood grain, stone or tile, etc. The texturing can be of the form of registered and embossed or only a smooth or matte finish. When two decors are present on different sides of the core one or both may have the same or different textures or surface qualities in addition to décor design. The surface or surfaces may also be covered with protective coating, lacquer, urethane, or other liquid surface that may contain hard particles or not. These coatings can be UV or radiation curable or not.

The edges of the chair mat can be milled or shaped (e.g., beveled) in a variety of forms. They can be square edge, though preferably, a smooth edge, to allow the easy movement of chair wheels to pass over the joint edge and to return to the chair mat surface. The edges may have a rounded shape, beveled and or beveled and round shape combined.

When designed with reversible surfaces, the top and bottom surfaces can have different decors providing a dual selection for the consumer and also reducing inventory space by 50% by showing two decors one on each of the upper and lower surfaces of the chair mat. This 50% reduction in shelf space opens additional shelf space for other products. This also enables a more frequent turn-over of product on this shelving space for the retailer. Instead of or in combination with different decors, the opposite decors may also have different textures. For example, while one may have a smooth slate look, the opposite side can have an embossed-in-register wood appearance.

Additional Construction Features:

The format of the chair mat may be one piece or several pieces for ease of shipping, placing on shelves and for the consumer to transport.

Examples can include, but not be limited to:

Two piece mat joined with a click, glue-less joint or glued joint or both

Two or more pieces joined with a click, glue-less joint or glued joint or both

The chair mat may have a resilient “snap-on” edging that may perform the function of rounding the edge and also function as a “gripping” material to stabilize the chair mat from excessive movement on the finished flooring beneath the chair mat. The edging may not necessarily have a function to assist the chair wheels to roll easily over the edge of the chair mat, but function as a “bumper” that prevents the wheel of the chair from easily rolling off the mat and also alerts the seated person that he has reached the edge of the chair mat. The shape of the “pieces” can take a variety of forms, from square to diamond shaped, virtually all multilateral shapes, from rectangles, hexagons, triangles and octangular shapes to name a few linear edge shapes, as well as curved, including regular and irregular curved shapes can define the shape of the pieces. The linear edged shapes may be regular or irregular shaped, e.g. an irregular hexagon having sides of different lengths or overlapping diamond shapes. When assembled, the pieces do not all have to be of the same shape, e.g., rectangular pieces can be assembled into a unit using triangular and/or hexagonal shapes. Alternatively, regular and irregular curved shapes may be combined with each other as well as with linear-edged shapes.

Kits:

The chair mats may be placed in kits:

1. The kit may include a one piece or a multiple piece chair mat;

2. The kit may, as described in 1, include gripping pad or pads to be used on the underside surface of the chair mat help prevent excessive movement on the finished flooring material beneath the chair mat; such pads may be removable, such that the pads can be provided as a separate piece and placed on the non-exposed décor; the pads may also be provided with an adhesive to adhere the pads to the non-exposed side of the mat;

3. The kit may include descriptions seen in 1 & 2 and include glue for joining;

4. The gripping pad or pads may be packaged separately within the kit or attached to the underside of the chair mat;

5. The kit can include assembly instructions, care and maintenance information; and

6. The kit can include a separate edging material that can be attached to the perimeter of the chair mat. This edging material may have edges to join with the edges or the chair mat, alternatively they may be joined with an adhesive, or even be a spring biased flexible peripheral band to surround the peripheral of the mat.

Method of Forming the Product of the Invention

A sheet of core material, HDF, MDF, particle board or other compositions, plastic, etc. that has a laminate bonded to its surface and also may have a contra laminate or other balancing material on the other side of the sheet. The element is typically 7×8 feet in DL laminate production, but not limited to this size. HPL production can also produce sheets approximately 4×8 feet.

This bonded element is then cut and milled into planks.

The chair mats would be cut from bonded elements—they would be one piece. In a bonded element of 7×8 feet four chair mats approximately 40″×48″ could be made. The chair mat can also include feet or other structures to hold the mat in place.

In addition to being used as a chair mat, the present invention can be a reversible floor. Specifically, individual floor planks, boards or tiles can be constructed with a first décor on a first side and a second décor on the second side. In most embodiments, the first décor is a laminate as described herein, and while the second décor can also be a laminate, the second décor can be of any type described herein (which may include hard particles to impart abrasion and/or scratch resistance). For example, one décor can be a digitally printed décor and the other include an impregnated paper layer.

In a preferred embodiment, the invention is sold as a single package or kit containing, for example, two or more individual planks or boards to be assembled, through, for example, tongue-and-groove joints, which preferably interlock on at least one side to prevent at least horizontal and preferably horizontal and vertical separation.

Although rectangular (e.g., square) panels are preferred, the panels can independently be of any regular or irregular geometric shape, e.g., octagonal, hexagonal, triangular; see those shown in U.S. Pat. Nos. 6,823,638; 6,854,235; 6,588,166; 6,920,732; 6,763,643; RE39,439; 6,536,178; 6,591,568; 6,601,359; 7,040,068; 7,003,924; U.S. Patent Publication Nos. 2007/0006543 A1; 2006/0099386A1 or International Publication No. WO 2006/043893, each incorporated in its entirety by reference. If the panels are all of the same shape, the dimensions need not be the same, as for example, rectangular panels of varying lengths/widths may be used. When the panels are all rectangular (with one set of long sides and one set of short sides), the long sides are usually joined by relative horizontal movement, but can be joined by relative rotational movement or relative vertical movement or a fold down movement, such as shown in the disclosure of the aforementioned WO 2006/043893 and U.S. Pat. Nos. 6,854,235 and 6,763,643 and U.S. Patent Publication No. 2007/0006543, especially the drawings thereof. Such relative horizontal movement can be a sliding motion along a side, joining only one entire side at once, or joining multiple sides at once, as shown in FIGS. 4-7 of U.S. Pat. No. 6,823,638. The short sides of such panels can also, but need not, be assembled by relative horizontal movement and may lock. The joints can include a slideable or deformable element, or in an alternative, a static element to hold the panels together once assembled, such as shown in the aforementioned WO 2006/043893 publication,and U.S. Pat. Nos. 6,920,732; 6,763,643; 6,729,091; and Patent Publication No. US 2007/0006543 A1.

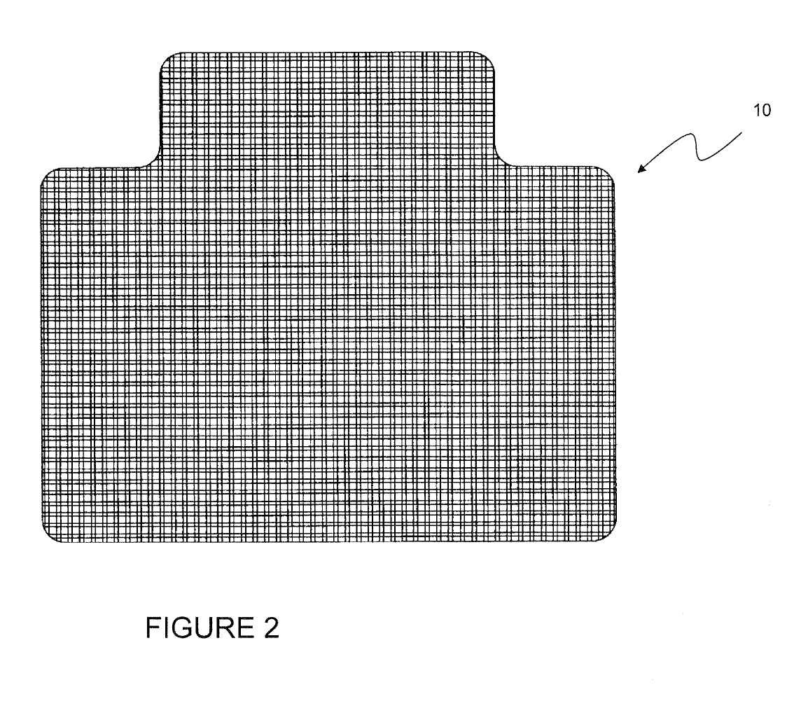

In order to reduce or eliminate penetration of water, dirt, debris, etc. into a gap between adjacent panels, the joint of the panels is preferably constructed as not to have any gaps therein. This is preferably accomplished by selecting a joint where the exposed upper surfaces of the panels abuts, as shown in FIG. 8 of U.S. Pat. No. 6,588,166, and FIG. 2 of U.S. Pat. No. 6,823,638. As depicted in these figures, one or both sides of the panels can also be beveled, i.e., provided with a ramp or incline to form a V-shape between the panels when assembled. Thus, in one embodiment of the invention one assembled surface of the chair mat has a flush construction, while the opposite side forms a beveled construction. Alternatively, both can form beveled or both can be flush assemblies. The bevel may also be formed by a relief, resulting in a structure resembling a square-wave, as opposed to a V-shape, when the panels are joined. If the construction of the second sides does not permit the decorative surfaces to abut (either beveled or flush), a sealant can be applied in the gap between the panels.

In another embodiment, where the joint results in both the upper surface and lower surface having no visible gaps therein, such can be achieved by the system shown in U.S. Pat. No. 6,729,091. In such a system, the panels are formed with only groove edges, and a joining means, or tongue is separately provided.

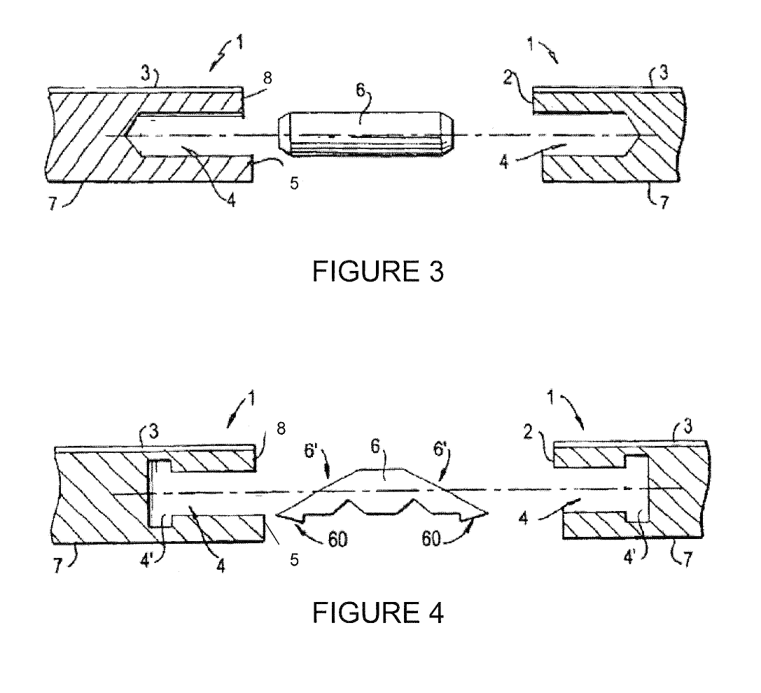

As shown in FIG. 3, element 1 is in all edges 2 provided with holes 4, which holes extend inwards from the edge 2 mainly parallel to the upper decorative layer 3. The holes 4 are intended to receive each one part of a guiding means 6—or joining element. The holes 4 extends parallel to the edge 2 which is closest adjacent to the edge 2 where the holes 4 are arranged. The floor elements 1 are provided with edges 2, second décor 7 and first décor 3. The elements 1 are intended to be joined by means of tongue 12 and groove 11.

A similar structure is shown in FIG. 4, where, in cross-section, parts of two elements 1 and one guiding means 6 according to yet another embodiment of the invention are depicted. The elements 1 are provided with edges 2, second décor 7 and a first décor 3. The elements 1 are intended to be joined by means of tongue 12 and groove 11. The elements 1 are at their edges 2 provided with holes 4, which holes 4 extends inwards from the edge 2 mainly parallel with the first décor 3. The holes are arranged on a predetermined distance from the first décor 3. The holes 4 are intended to each receive one part of a guiding means 6. The holes 4 are provided with an inner gripping edge 4′ which can be achieved by milling a step with larger diameter than the holes 4 on a predetermined depth after the drilling or by a broaching step. The guiding means 6 is, in this embodiment, provided with two ends 6′ each, which each are provided several resilient protrusions 60 which are intended to interact with gripping edges 4′ of the holes 4 during assembly.

The edges 2 of the elements 1 need not be in a common plane. In order to form a strong joint, while ensuring that the upper and lower surfaces both join without any visible gaps, the distal noses of the edges, for example, the nose of the lower edge 5, is shown as being shorter than the nose of the upper edge 8. However, because the noses of the adjacent element 1 are also of different lengths (but reversed), when the two elements are joined, both the upper surface and lower surface, simultaneously produce a surface without gaps.

In another embodiment, the joint between the panels is formed, in part, with a joining element. See, e.g., U.S. Pat. No. 6,920,732 and others. While one side of the panels forms a flush (or beveled) connection with an adjacent panel, when the opposite side is exposed, the joining element is exposed. Thus, the joining element can be provided with a décor which will match with, contrast with or be part of the décor provided by that side of the panel. For example, if the overall décor is to be a ceramic tile motif, the joining element can form part of the grout line between the visual ceramic tiles. If the overall décor is a terrazzo or mosaic motif, the joining element can be part of the border between adjacent segments. Due to the construction of the panels, it may also be possible to have some panels with the first décor exposed, and some panels, of the same structure, with the second décor exposed, thereby providing the designer with increased choices when installing a surface.

The particular construction of the invention allows for additional uses to protect household surfaces from damage. In one embodiment, the bonded element is formed into a coaster, to hold either a beverage glass (in a smaller form), a potted plant (either as or in place of a conventional saucer) or a pet foot/water dish. During use, the bonded element would protect an underlying surface from contacting any water or other liquid. In a preferred embodiment, the bonded element includes the molded rim material, described above, which would function as a damming lip to help to limit liquid from running over the side of the bonded element. In still further embodiments of the invention, the product can take the form of a trivet, cutting board, or other protective elements for countertops, tables, or other furniture surfaces and anywhere that a protective surface may be employed using the features of the invention.

In forming the chair mat of the invention, typically a larger, usually rectangular (or square) sheet is cut into the irregular chair mat shape. The waste material can be used to form the coaters, plant saucer, trivets, cutting boards or other smaller floor (or other household surface) protectors.

By use of this invention, retailers can reduce necessary shelf-space. Because two decors are now shared by a single product, retailers can show two products that only take up the shelf space that a single product does. Such a revolutionary design allows for a 50% reduction in the necessary shelf space, transport, transaction costs and a variety of extra fees/charges and necessities, including reducing SKU numbers, pattern numbers and other inventory and accounting functions.

The structures of the invention are typically used in the construction of a surface, such as a top for a counter or table, floor, ceiling, wall or moveable mat/pad. Such surfaces are often found in residential structures (e.g., single and multi-family houses, condominiums, townhomes, co-operatives, apartments, and lobbies of such buildings), commercial structures (e.g., retail stores, strip malls, shopping malls, office buildings, hotels, restaurants, supermarkets, banks, churches, airports and other transit stations), public structures (e.g., stadiums and arenas, schools, museums, theaters, post offices, hospitals, courthouses and other government buildings), as well as industrial structures (e.g., manufacturing plants, mills, and warehouses) and vehicles (e.g., ships. trains, aircraft, public and private busses, cars and other motor vehicles).

It should be apparent that embodiments other than those specifically described above may come within the spirit and scope of the present invention. Hence, the present invention is not limited by the above description.

What is claimed:

1. A protective mat having two major surfaces, one being an upper surface and the other being a lower surface, the upper and lower surfaces each being provided with a decorative surface and each decorative surface being bonded to a core.

2. The mat of claim 1, wherein the core is one selected from the group consisting of fiberboard, particle board, plywood, wood, flaxboard, stone, cardboard, concrete, gypsum, high density fiber reinforced plasters, plywood, oriented strandboard, metals and metal alloys.

3. The mat of claim 1, wherein the core is made of cellulosic particles bonded together with a binder.

4. The mat of claim 2, wherein the core is HDF or MDF.

5. The mat of claim 1, wherein the décor on the upper surface differs from the décor on the lower surface.

6. The mat of claim 1, wherein the mat is formed from a plurality of smaller pieces, which smaller pieces are held together with joining elements.

7. The mat of claim 6, wherein the joining elements comprise a spring placed between the smaller pieces at a joint thereof.

8. The mat of claim 6, wherein the joining elements comprise tongue and groove portions, which tongue and groove portions are configured to be assembled by relative rotational movement.

9. The mat of claim 6, wherein the joining elements comprise tongue and groove portions with locking elements, which tongue and groove portions are configured to be assembled by relative horizontal movement.

10. The mat of claim 6, wherein the joining elements comprise tongue and groove portions which are configured to be assembled by relative vertical movement.

11. The mat of claim 6, wherein the joining elements comprise a cavity in an edge of each piece which adjoins another piece, and the joining element further comprises a separate joining element.

12. The mat of claim 6, further comprising a frame for at least a portion of the periphery of the assembled pieces.

13. A kit comprising at least the smaller pieces of claim 6 and a frame for at least a portion of the periphery of the assembled pieces.

14. The mat of claim 1, wherein the mat is in the form of a chair mat.

15. The mat of claim 1, wherein the core comprises a plurality of phenolic impregnated papers.

16. The mat of claim 1, wherein at least one of the upper surface, the lower surface, or the core further comprise an antimicrobial substance.

17. The mat of claim 1 in the form of a cutting board.

18. The mat of claim 1 in the form of a coaster.

19. The mat of claim 1, wherein at least one of the upper and lower decorative surfaces comprises a décor printed directly on the core.

20. The mat of claim 1, wherein at least one of the upper or lower decorative layers further comprises a wear layer containing particles having a Moh's hardness of at least 6.

21. The mat of claim 1 further comprising a dampening foil between the decorative surface and the core.
